(19) United States
(12) Patent Application Publication
(10) Pub. No.: US 2009/0038337 A1
(43) Pub. Date: Feb. 12, 2009

(54) Method for Regulating a Series of Apparatus for Separating Air by Cryogenic Distillation and Series of Apparatus for Separating Air Operating According to Said Method

(75) Inventor: Jean-Francois Rauch, Joinville Le Pont (FR)

Correspondence Address: AIR LIQUIDE;Intellectual Property, 2700 POST OAK BOULEVARD, SUITE 1800, HOUSTON, TX, 77056, US

(73) Assignees: L'Air Liquids Societe Anonyme Pour L'Etude Et; L'Air Liquide Societe Anonyme Pour L'Etude Et L'Exploitation Des Procedes Georges Claude, Paris (FR)

(21) Appl. No.: 12/162,500

(22) PCT Filed: Jan. 18, 2007
(86) PCT No.: PCT/EP2007/050511

§ 371 Date: Jul. 29, 2008

(30) Foreign Application Priority Data
Jan. 31, 2006 (FR) 0650333

(51) Int. Cl. F25J 3/04; B01D 53/047

(52) U.S. Cl. 62/640; 62/641; 62/642; 62/643; 95/106

(57) ABSTRACT

In a method for regulating a series of apparatus for separating air by cryogenic distillation, the series comprising N air separation apparatus (1, 2, 3, 4), where N>1, an air gas having substantially the same composition is sent from the N apparatus to a consuming unit (5), each apparatus comprising a system of distillation columns (1B, 2B, 3B, 4B) and an air purification unit (1A, 2A, 3A, 4A) of the type in which at least two adsorbers are used, each, with a phase shift, following the same cycle in which an adsorption phase, at a high cycle pressure, and a regeneration phase with depressurization, succeed one another, terminating in a repressurization of the adsorber, the method comprising a step in which the adsorbers of a unit are placed in parallel, each apparatus having an adsorption cycle time and the operation of at least some of the purification units is regulated so that the repressurization step for one apparatus begins at a different time from the beginning of the repressurization for another apparatus.

The present invention relates to a method for regulating a series of apparatus for separating air by cryogenic distillation, comprising at least two apparatus for separating air by cryogenic distillation.

For cryogenic distillation, the gas processed must be dry and decarbonated to prevent the formation of ice in the cold box.

One of the most efficient systems for purifying air is to treat the gas in a head end purification unit. The system comprises two cylinders, one operating in adsorption, the other in one of the regeneration steps.

On certain sites, a plurality of cryogenic distillation units are installed to produce the necessary quantity of gas.

With the head end purification, one of the steps of the regeneration sequence consists in repressurizing the cylinder which has been regenerated, before switching it to adsorption.

For a total cycle of 120 to 300 minutes, the pressurization step generally takes between 5 and 20 minutes. This period depends on the additional air flow available for repressurization.

In general, between 2 and 10% of the air flow (with regard to the nominal flow rate) is used to repressurize a cylinder. The quantity of air sent to the separation apparatus is therefore reduced commensurately during the pressurization. On sites with several air separation apparatus, the steps of the desiccation sequence are independent of one another.

On a site with N air units (N>=2), there is a probability of having up to N pressurization steps simultaneously.

It is one object of the present invention to have the least possible number of simultaneous pressurization steps.

According to one object of the invention, a method is provided for regulating a series of apparatus for separating air by cryogenic distillation, the series comprising N apparatus for separating a gas mixture, particularly air, where N>1, in which a gas having substantially the same composition is sent from the N apparatus to a consuming unit, each apparatus comprising a system of distillation columns and an adsorption unit of the type in which at least two adsorbers are used, each, with a phase shift, following the same cycle in which an adsorption phase, at a high cycle pressure, and a regeneration phase with depressurization, succeed one another, terminating in a repressurization of the adsorber the method comprising a step in which the adsorbers of a unit are placed in parallel, each apparatus having an adsorption cycle time characterized in that the operation of at least some of the purification units is regulated so that the repressurization step for one apparatus begins at a different time from the beginning of the repressurization for another apparatus.

According to other optional aspects:
the gas mixture is purified in the adsorption unit upstream of the system of columns for each apparatus,
the operation of the adsorption units is regulated so that the unit repressurization steps all take place in different periods,
the operation of the adsorption units is regulated so that at least some of the adsorption units operate at least occasionally with different cycle times,
the cycle time of at least one adsorption unit is modified during operation so that the repressurization steps are not simultaneous,
the gas mixture is air and at least two of the apparatus feed oxygen gas and/or nitrogen gas, which is preferably pressurized, to the consuming unit,
the adsorption units are regulated so that a multiple of M/N seconds elapses between the end of cycle of one apparatus and the end of cycle of the other apparatus, where M is the average cycle time for the N apparatus,
the cycle time of at least one adsorption unit is modified while the cycle is still in progress,
the cycle time of at least one adsorption unit is modified according to the temperature of a gas issuing from the adsorption unit and/or according to the composition of a gas issuing from the adsorption unit,
the repressurization step for one apparatus begins at least 90 minutes, preferably at least 75 minutes, indeed at least 50 minutes, indeed at least 40 minutes, before or after the beginning of the repressurization for another apparatus,
for each apparatus, the adsorption unit only comprises two adsorbers.

According to another object of the invention, a series of apparatus is provided for separating a gas mixture, optionally air, by cryogenic distillation, the series comprising N apparatus for separating a gas mixture, where N>1, each apparatus feeding a consuming unit with a gas from the air having substantially the same composition and each apparatus comprising a system of distillation columns and an adsorption unit of the type in which at least two adsorbers are used, each, with a phase shift, following the same cycle in which an adsorption phase, at a high cycle pressure, and a regeneration phase with depressurization, succeed one another, terminating in a repressurization of the adsorber the method comprising a step in which the adsorbers are placed in parallel, each apparatus having a cycle time characterized in that it comprises means for regulating the operation of at least some of the purification units so that the repressurization step for one apparatus begins at a different time from the beginning of the repressurization for another apparatus.

Optionally, the series comprises a common heater (RC) for heating a regeneration gas issuing from a first system of columns of a first of the N apparatus upstream of a first adsorption unit, and for heating a regeneration gas issuing from a second system of columns of a second of the N apparatus upstream of a second adsorption unit.

The invention is described in greater detail with reference to the figures appended hereto in which:

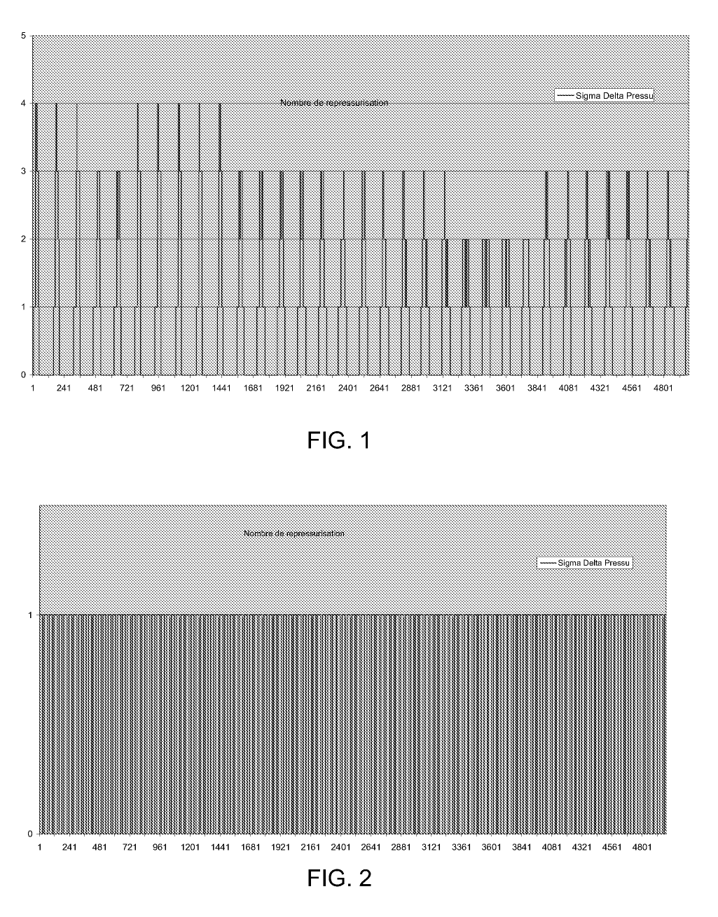

FIG. 1 shows the number of simultaneous pressurizations at a given moment without the invention.

FIG. 2 shows the number of simultaneous pressurizations at a given moment with the invention.

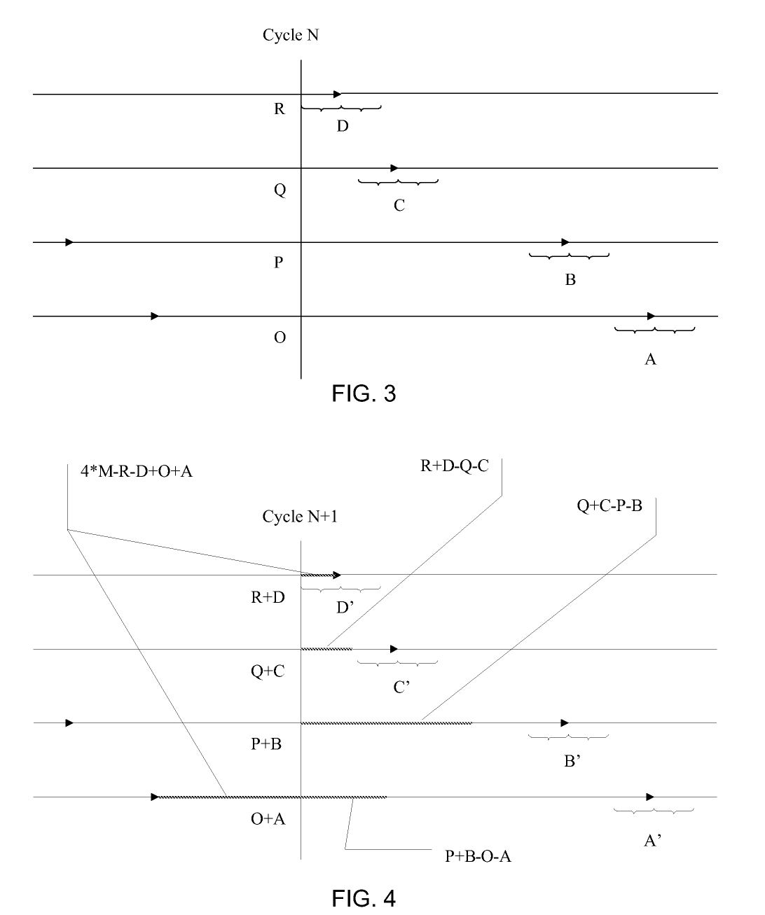

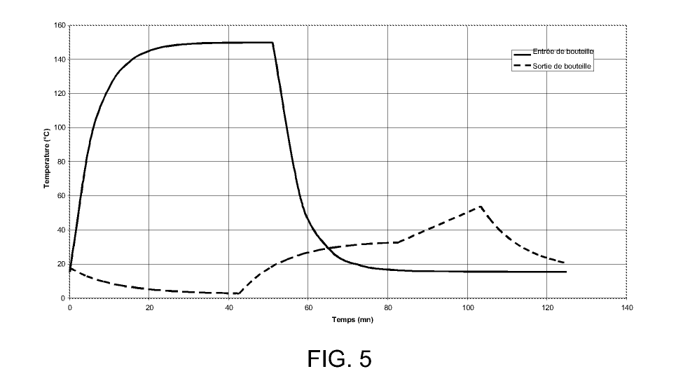

FIGS. 3 and 4 show variations in the cycle times for a series of four air separation apparatus according to the invention.

FIG. 5 shows the variation in the temperatures of the flows entering and issuing from an adsorption cylinder.

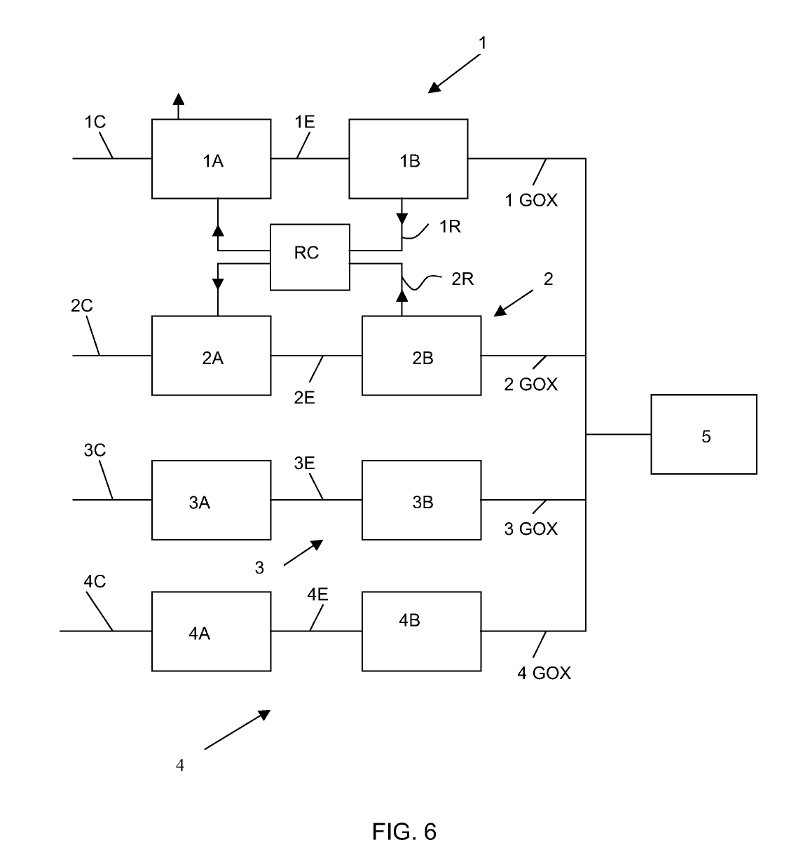

FIG. 6 shows a series of four air separation apparatus according to the invention.

FIG. 1, with the number of simultaneous pressurizations on the y-axis and time on the x-axis, shows that on a site with four air separation units feeding the same client, there may be 2, 3 or 4 pressurizations simultaneously, resulting in a decrease in purity and/or quantity of product for the final client supplied by several of the apparatus.

The invention applies to all air separation methods with at least a double column (medium pressure column and low pressure column) with oxygen production called pumped: that is, the liquid oxygen drawn at the bottom of the low pressure column is pumped at a pressure higher than 10 bar, before being vaporized in one or more heat exchangers.

The invention also applies to apparatus producing impure oxygen by the mixing column principle.

The invention consists in determining for each cycle of each air separation unit, whether this cycle must be slightly increased or, on the contrary, slightly decreased, to ensure that ultimately, all the sequences of the various air separation units are desynchronized.

At the normal end of the cycle of a cylinder, the state of progress of the cycle of the other units serves to calculate the number of minutes by which the cycle of the cylinder concerned must be increased or decreased.

For example, for a cylinder already under repressurization, the cycle time of the other unit(s) is increased (within a reasonable limit, for example 10 minutes) to await, if possible, the end of repressurization of the other system.

As shown in FIGS. 3 and 4, the operator determines the pilot unit, unit 4 here. The calculation is carried out for all the units when the pilot unit is close to the end of its cycle (that is at CycleTime−DeltaMax).

DeltaMax is the maximum permissible variation of a cycle for adjusting the cycle time.

Each unit is in one cycle step (necessarily shorter than the pilot unit).

We therefore have:
unit 1 at time O
unit 2 at time P,
unit 3 at time Q,

and the pilot unit 4 at time R where R=(CycleTime)−(DeltaMax)=4M−(DeltaMax)

Let us assume M=(CycleTime)/4.

We can now calculate the unknowns A, B, C and D that will limit or increase the cycles of the unit 1, 2, 3 or 4 in order to have M minutes between two ends of cycle.

The system must solve the following problems:

4M−R+O+A−D=M

P−O+B−A=M

Q−P+C−B=M

R−Q+D−C=M

Let:

A=R−O−3*M+D

B=R−P−2*M+D

C=R−Q−M+D

Any D; this system is an infinity of solutions, but we know that A, B, C and D must be between −DeltaMax and +DeltaMax.

Let us assume D such that A+B+C+D=0 (when the system is stable, the solution must be A=B=C=D=0).

This gives D=(−3*R+O+P+Q+6*M)/4.

The solution of the system is then:

D=Maximum(−DeltaMax; Minimum(+DeltaMax; (−3*R+O+P+Q+6*M)/4))

C=Maximum(−DeltaMax; Minimum(+DeltaMax; (−3*Q+R+O+P+2*M)/4))

B=Maximum(−DeltaMax; Minimum(+DeltaMax; (−3*P+Q+R+O−2*M)/4))

A=Maximum(−DeltaMax; Minimum(+DeltaMax; (−3*O+P+Q+R−6*M)/4))

The calculation method described above is a simple one; obviously, other more complicated methods may be considered.

Thanks to the invention, the maximum energy demand corresponds to the total design demand plus the extra demand corresponding to a single pressurization. This helps significantly to reduce the size and hence the cost of the energy input system.

For example, with four air separation apparatus, a 5% repressurization air demand and an air compression energy issuing from a water vapor expansion, the maximum vapor consumption for the four apparatus would be 4*Design+5%*Design=405 Design in place of 4*Design+4*5%*Design=420 Design according to the prior art.

The maximum time that the system can use depends on the load of the unit. Hence at high load, the system can increase or reduce the cycle time by 5 minutes (for example). At reduced load (the sequence being longer), the system can increase or reduce the cycle time by 10 minutes.

At reduced load, the cycle time may also be increased by 10 minutes and reduced by 20 minutes (according to the progress of the cooling step, that is, the offgas temperature leaving the cylinder in the cooling step is cold enough. As shown in FIG. 5, the cylinder outlet temperature falls at the beginning of cycle, then increases until a heat peak is reached, about 105 minutes in the figure. Once this peak has been passed, the cycle time can be shortened, for example if the offgas temperature is lower than the normal offgas temperature +10° C. or than the ambient temperature +10° C.

The limit for the maximum increase in the cycle can be set by increasing the carbon dioxide content leaving the cylinder above a given threshold. For example, if the content increases to 1 ppm of carbon dioxide over a threshold, the cylinder must be replaced.

In this way, the difference between two repressurization step beginnings for two apparatus of the system is about 37 minutes.

This system also serves to use the same heater for two or more units. This is because the regeneration periods for a hot gas are also desynchronized.

Since the total compressed flow rate in all of the air compressors varies less than with the prior art, its energy consumption varies less, thereby providing an additional advantage:
When the compression energy is obtained by water vapor expansion, the vapor consumption varies less (less disturbance in the vapor network, hence no risk of lowering the pressure of the vapor manifold).
When the compressor is driven by an electric motor, it is much easier to predict the electric power consumption of the unit, and thereby to optimize the invoice (especially if the cost of energy is based on a fixed part and a variable part).

FIG. 6 shows a series of four air separation apparatus. The apparatus 1 receives compressed air 1C. This air is purified in the adsorption unit 1A whereof the cycle is set according to the invention and the adsorption unit produces an offgas flow 1W which serves for regeneration, this flow 1R issuing from the system of distillation columns 1B. The purified air 1E is sent to the system of columns 1B and is separated to form an oxygen gas flow 1GOX by vaporizing the liquid oxygen pumped or by any other known means.

Each of the apparatus 2, 3 and 4 operates substantially in the same way as described for the apparatus 1, and they are not described in detail. The apparatus 1 to 4 may, for example, be pump apparatus as described in “The Technology of Catalytic Oxidations”, Editions Technip, Arpentinier et al, or mixing column apparatus. The flows 1GOX, 2GOX, 3GOX and 4GOX are sent to a consuming unit 5, such as a gasification unit or a partial oxidation unit.

A common heater serves to heat the regeneration flows 1R, 2R because the reheating of the two flows does not take place simultaneously.

It is easy to understand that the invention can be used in a series of apparatus for separating a mixture having hydrogen and/or carbon monoxide and/or methane and/or nitrogen as its main components.

1-11. (canceled)

12. A method for regulating a series of apparatus for separating air by cryogenic distillation, the series comprising N air separation apparatus (1, 2, 3, 4), where N>1, in which a gas having substantially the same composition is sent from the N apparatus to a consuming unit (5), each apparatus comprising a system of columns for distilling a gas mixture (1B, 2B, 3B, 4B), particularly air, and a unit for adsorbing the gas mixture, particularly air (1A, 2A, 3A, 4A) of the type in which at least two adsorbers are used, each, with a phase shift, following the same cycle in which an adsorption phase, at a high cycle pressure, and a regeneration phase with depressurization, succeed one another, terminating in a repressurization of the adsorber, the method comprising a step in which the adsorbers of a unit are placed in parallel, each apparatus having an adsorption cycle time characterized in that the operation of at least some of the purification units is regulated so that the repressurization step for one apparatus begins at a different time from the beginning of the repressurization for another apparatus.

13. The method as claimed in claim 12, in which the operation of the adsorption units (1A, 2A, 3A, 4A) is regulated so that the unit repressurization steps all take place in different periods.

14. The method as claimed in claimed 12, in which the operation of the adsorption units (1A, 2A, 3A, 4A) is regulated so that at least some of the adsorption units operate at least occasionally with different cycle times.

15. The method as claimed in claim 14, in which the cycle time of at least one unit (1A, 2A, 3A, 4A) is modified during operation so that the repressurization steps are not simultaneous.

16. The method as claimed in claim 12, in which the gas mixture is air and at least two of the apparatus feed oxygen gas and/or nitrogen gas to the consuming unit.

17. The method as claimed in claim 12, in which the adsorption units (1A, 2A, 3A, 4A) are regulated so that a multiple of M/N seconds elapses between the end of cycle of one apparatus and the end of cycle of the other apparatus, where M is the average cycle time for the N apparatus.

18. The method as claimed in claim 12, in which the cycle time of at least one adsorption unit (1A, 2A, 3A, 4A) is modified while the cycle is still in progress.

19. The method as claimed in claim 12, in which the cycle time of at least one adsorption unit (1A, 2A, 3A, 4A) is modified according to the temperature of a gas (1W) issuing from the adsorption unit and/or according to the composition of a gas (1W) issuing from the adsorption unit.

20. The method as claimed in claim 12, in which the repressurization step for one apparatus begins at least 90 minutes before or after the beginning of the repressurization for another apparatus.

21. A series of apparatus for separating air by cryogenic distillation, the series comprising N apparatus for separating a gas mixture, particularly air (1, 2, 3, 4), where N>1, each apparatus feeding a consuming unit (5) with a gas having substantially the same composition and each apparatus comprising a system of distillation columns (1B, 2B, 3B, 4B) and a unit for purifying the gas mixture, particularly air (1A, 2A, 3A, 4A) of the type in which at least two adsorbers are used, each, with a phase shift, following the same cycle in which an adsorption phase, at a high cycle pressure, and a regeneration phase with depressurization, succeed one another, terminating in a repressurization of the adsorber, the method comprising a step in which the adsorbers are placed in parallel, each apparatus having a cycle time characterized in that it comprises means for regulating the operation of at least some of the purification units so that the repressurization step for one apparatus begins at a different time from the beginning of the repressurization for another apparatus.

22. The series as claimed in claim 21, comprising a common heater (RC) for heating a regeneration gas (1R) issuing from a first system of columns (1B) of a first of the N apparatus upstream of a first adsorption unit, and for heating a regeneration gas (2R) issuing from a second system of columns (2B) of a second of the N apparatus upstream of a second adsorption unit.
